(19) United States
(12) Patent Application Publication
(10) Pub. No.: US 2026/0037125 A1
(43) Pub. Date: Feb. 5, 2026

(54) STORAGE SYSTEM

(71) Applicant: Hitachi Vantara, Ltd., Yokohama-shi (JP)

(72) Inventors: Takashi AMANO, Tokyo (JP); Akira DEGUCHI, Tokyo (JP)

(73) Assignee: Hitachi Vantara, Ltd., Yokohama-shi (JP)

(21) Appl. No.: 19/078,829

(22) Filed: Mar. 13, 2025

(30) Foreign Application Priority Data
Aug. 2, 2024 (JP) 2024-128128

(51) Int. Cl. G06F 3/06

(52) U.S. Cl. CPC G06F 3/0608; G06F 3/065; G06F 3/067

(57) ABSTRACT

A controller acquires processor load information on the controller and a copy destination storage system, and selects one of a plurality of transfer methods for transferring data to the copy destination storage system based on processor loads. The plurality of transfer methods includes a first transfer method for performing compression processing on transfer data, and a second transfer method for performing no compression processing on the transfer data or performing the compression processing on the transfer data with a processor load lower than that of the first transfer method. The first transfer method is selected under conditions including where each processor and the copy destination storage system is equal to or less than a threshold. The second transfer method is selected under conditions including a condition where at least one of the processor loads of the controller and the copy destination storage system is higher than the threshold.

### CLAIM OF PRIORITY

The present application claims priority from Japanese patent application JP 2024-128128 filed on Aug. 2, 2024, the content of which is hereby incorporated by reference into this application.

### BACKGROUND OF THE INVENTION

### 1. Field of the Invention

The present invention generally relates to a remote copy of data from a primary storage system to a secondary storage system.

### 2. Description of the Related Art

A technique related to a remote copy of data from a primary storage system to a secondary storage system is known. The amount of data transferred between the storage systems for the remote copy is preferably small. This is because small data can contribute to reduction in resources that are bases of a communication band between the storage systems, for example.

For example, JP 2022-133058 A discloses a technique of compressing transfer data and copying the transfer data to a remote. Specifically, a plurality of target data is constantly compressed and transferred from a primary storage to a secondary storage to increase a compression rate.

### SUMMARY OF THE INVENTION

The technique disclosed in JP 2022-133058 A causes transfer data to be transferred to a remote while always compressing the transfer data. When the transfer data is compressed, overhead of compression processing is added in a primary storage to increase a processor load. Then, overhead of extension processing is added in a secondary storage to increase a processor load. The storages each process I/O from a host to cause the processor load to fluctuate up and down. When the compression processing or the extension processing of the transfer data is performed with a high processor load in the storage, copy performance may be deteriorated to fail to maintain a short point recovery objective (RPO).

An aspect of the present invention is a storage system that transmits copy data to a copy destination storage system, the storage system including a controller and a storage drive that stores user data. The controller acquires processor load information on the controller and processor load information on the copy destination storage system, and selects one transfer method from a plurality of transfer methods for transferring the user data to the copy destination storage system based on a processor load of the controller and a processor load of the copy destination storage system. The plurality of transfer methods includes a first transfer method for performing compression processing on transfer data and a second transfer method for performing no compression processing on the transfer data or performing compression processing on the transfer data with a lower processor load than the first transfer method. The first transfer method is selected under conditions including a condition where each of processor loads of the controller and the copy destination storage system is equal to or less than a threshold. Then, the second transfer method is selected under conditions including a condition where at least one of the processor loads of the controller and the copy destination storage system is more than the threshold.

According to an aspect of the present invention, a short RPO can be maintained by suppressing a decrease in copy performance.

### BRIEF DESCRIPTION OF THE DRAWINGS

FIG. 1 illustrates a configuration example of an entire system;

FIG. 2 illustrates a configuration example of a storage system and a maintenance terminal;

FIG. 3 illustrates an example of an outline of a remote copy from a primary storage system to a secondary storage system;

FIG. 4 illustrates a configuration example of a memory of a storage system;

FIG. 5 illustrates a configuration example of an SEQ # table;

FIG. 6 illustrates a configuration example of a journal control block (JNCB);

FIG. 7 illustrates a configuration example of a distance table;

FIG. 8 illustrates a configuration example of a required multiplicity table;

FIG. 9 illustrates a configuration example of a compressed information table;

FIG. 10 illustrates a processing flow of write processing performed by a primary storage system;

FIG. 11 illustrates a processing flow of a journal (JNL) transfer processing;

FIG. 12 illustrates a processing flow of a JNL read schedule program;

FIG. 13 illustrates a processing flow of a restore program;

FIG. 14 illustrates a configuration example of a compression algorithm table; and

FIG. 15 illustrates a configuration example of a primary volume (PVOL) table.

### DESCRIPTION OF THE PREFERRED EMBODIMENTS

In the following description, an “interface device” may be one or more interface devices. The one or more interface devices may be at least one of the following.

One or more input/output (I/O) interface devices. An input/output (I/O) interface device is an interface device for at least one of an I/O device and a remote display computer. The I/O interface device for the display computer may be a communication interface device. The at least one I/O device is a user interface device that may be any one of an input device such as a keyboard or a pointing device, and an output device such as a display device.

One or more communication interface devices. The one or more communication interface devices may be one or more communication interface devices of the same type (e.g., one or more network interface cards (NIC)) or two or more communication interface devices of different types (e.g., an NIC and a host bus adapter (HBA)).

In the following description, a “memory” is one or more memory devices that are each an example of one or more storage devices, and may typically be a main storage device. The at least one memory device in the memory may be a volatile memory device or a nonvolatile memory device.

In the following description, a “permanent storage device” may be one or more permanent storage devices that are each an example of one or more storage devices. The permanent storage device may typically be a nonvolatile storage device (e.g., an auxiliary storage device), and specifically may be a hard disk drive (HDD), a solid state drive (SSD), a non-volatile memory express (NVME) drive, or a storage class memory (SCM), for example.

In the following description, a “storage device” may be at least a memory of the memory and a permanent storage device.

In the following description, a “processor” may be one or more processor devices. Although the at least one processor device may typically be a microprocessor device such as a central processing unit (CPU), it may be another type of processor device such as a graphics processing unit (GPU). The at least one processor device may be a single core or a multi-core. The at least one processor device may be a processor core. The at least one processor device may be a processor device in a broad sense such as a circuit (e.g., a field-programmable gate array (FPGA), a complex programmable logic device (CPLD), or an application specific integrated circuit (ASIC)) that is an aggregate of gate arrays in a hardware description language, the circuit performing a part or all of processing.

Although information allowing an output to be obtained against an input will be described with an expression such as “xxx table” in the following description, the information may be data with any structure (e.g., it may be structured data or unstructured data), or may be a neural network that generates an output against an input, or a learning model represented by a genetic algorithm or a random forest. Thus, the “xxx table” can be referred to as “xxx information”. Although each table has a configuration in the following description, the configuration is an example, and one table may be divided into two or more tables, or all or a part of two or more tables may constitute one table.

Additionally, although processing may be described with a “program” as a subject in the following description, the program is executed by a processor to perform determined processing appropriately using a storage device and/or an interface device, and thus the subject of the processing may be the processor (or a device or a system including the processor). The program may be installed in a device such as a computer from a program source. The program source may be a program distribution server or a computer-readable recording medium (e.g., a non-transitory recording medium), for example. In the description below, two or more programs may be implemented as one program, or one program may be implemented as two or more programs.

A “volume” (VOL) is a logical storage region. The volume may be a substantial volume (RVOL) or a virtual volume (VVOL). The “RVOL” may be a VOL based on a storage device, and the “VVOL” may be a volume according to a capacity virtualization technology (typically, thin provisioning).

A “storage system” may a system including a plurality of storage devices and a controller that performs I/O of data for the plurality of storage devices, or may a system including one or more physical computers. The latter system may be configured such that each of one or more physical computers executes predetermined software to construct the one or more physical computers as software-defined anything (SDx), for example. As the SDx, a software-defined storage (SDS) or a software-defined datacenter (SDDC) can be used, for example.

In the following description, when elements identical in kind are described without being distinguished, common reference numerals among reference numerals may be used, and when elements identical in kind are described while being distinguished, reference numerals may be used.

An embodiment herein describes a method for transferring copy data in consideration of a load of a copy destination storage system. An embodiment herein controls compression processing for data transfer based on processor load information on a copy source storage system and processor load information on a copy destination storage system. Copy performance can be prevented from deteriorating by performing no compression processing or selecting compression processing with a smaller processor load. The compression processing with a small processor load is performed by selectively compressing a part of the transfer data or selecting a compression algorithm with a small processor load, for example.

### First Embodiment

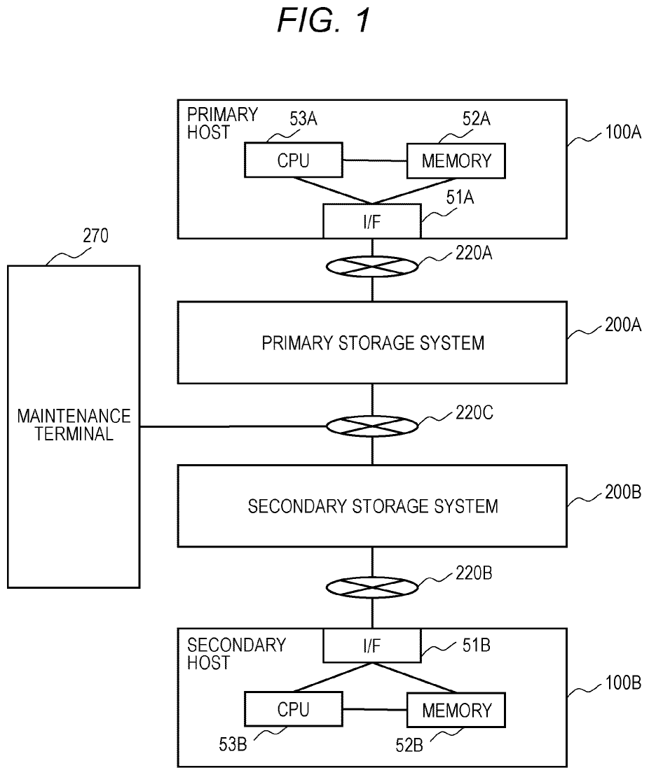

FIG. 1 illustrates a configuration example of an entire system according to a first embodiment.

A primary host 100A is connected to a primary storage system 200A through a network 220A (e.g., a front-end network). A secondary host 100B is connected to a secondary storage system 200B through a network 220B (e.g., a front-end network).

The primary storage system 200A and the secondary storage system 200B are connected through a network 220C (e.g., a back-end network). Two or more of the networks 220A to 220C may be common, or at least one of the networks 220A to 220C may be a dedicated line.

A primary site (site including the primary host 100A and the primary storage system 200A) and a secondary site (site including the secondary host 100B and the secondary storage system 200B) may be geographically separated. The primary host 100A is a computer including an interface device 51A, a memory 52A, and a central processing unit (CPU) 53A. The secondary host 100B is a computer including an interface device 51B, a memory 52B, and a CPU 53B.

The primary host 100A may be a virtual device (e.g., a virtual machine (VM) or a container). Similarly, the secondary host 100B may be a virtual device. The primary host 100A may be a virtual device and provided in the primary storage system 200A, and similarly, the secondary host 100B may be a virtual device and provided in the secondary storage system 200B (i.e., at least one of the storage systems 200A and 200B may be a so-called hyper-converged storage system). The secondary host 100B may not be provided.

When a distance between the storage systems 200A and 200B is short, for example, the primary host 100A may be connected to the secondary storage system 200B in addition to the primary storage system 200A. The secondary host 100B may be connected to the primary storage system 200A in addition to the secondary storage system 200B. Both or one of the storage systems 200A and 200B may be a system installed at co-location or a system on a cloud that provides a cloud computing service (storage service).

The primary host 100A executes software (e.g., a database management system (DBMS)) for executing business processing to transmit a data write request to the primary storage system 200A. The primary storage system 200A stores data according to the data write request.

Between the storage systems 200A and 200B, a remote copy is performed. That is, the secondary storage system 200B receives data from the primary storage system 200A and stores the received data. When the primary host 100A or the primary storage system 200A has a failure, disaster recovery is performed. Consequently, the secondary host 100B can continue the business processing of the primary host 100A using the data in the secondary storage system 200B. A remote copy system includes the storage systems 200A and 200B.

There is a maintenance terminal 270 connected to the network 220C. The maintenance terminal 270 communicates with at least one of the storage systems 200A and 200B for maintenance or management of the storage system. The maintenance terminal 270 may be connected to the network 220A to maintain the primary storage system 200A. Another maintenance terminal 270 may be connected to the network 220B to maintain the storage system 200B.

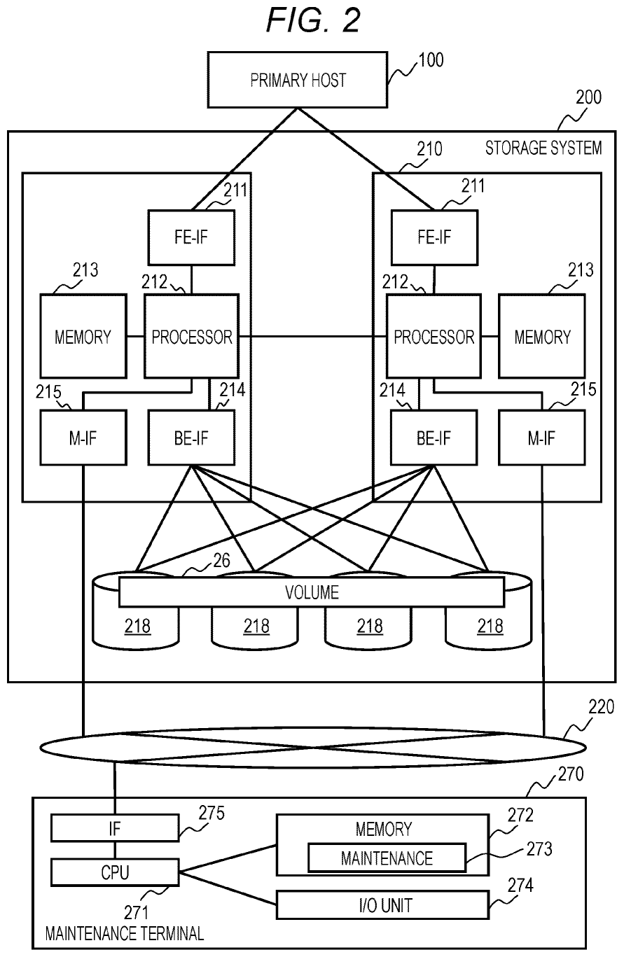

FIG. 2 illustrates a configuration example of the storage system 200 and the maintenance terminal 270. The reference signs excluding some or all of the alphabets of other reference signs mean any one component or a plurality of components of other reference signs.

The storage system 200 includes a storage drive group (a plurality of drives 218) and a redundant controller 210 that performs data I/O for the storage drive group. A storage drive is also simply referred to as a drive. Each drive 218 is an example of a persistent storage device. A drive group may constitute one or more redundant array of independent (or inexpensive) disks (RAID) groups. Based on the drive group, a volume 26 is provided.

The controller 210 includes a front-end interface (FE-IF) 211, a back-end interface (BE-IF) 214, a management interface (M-IF) 215, a memory 213, and a processor 212 connected thereto. The IFs 211, 214, and 215 are each an example of the interface device.

The FE-IF 211 is an interface device that communicates with a host 100. The FE-IF 211 may have a plurality of ports (e.g., Fibre Channel port, iSCSI port). A path of the remote copy (a path through which data to be transferred passes) may include a port of the FE-IF 211 of the primary storage system 200A and the port of the FE-IF 211 of the secondary storage system 200B. An interface device for the remote copy may be provided separately from an FE-IF 200.

The BE-IF 214 is an interface device that communicates with each drive 218.

The M-IF 215 is an interface device that communicates with the maintenance terminal 270. The M-IF 215 includes a port that may be included in the path of the remote copy instead of the port of the FE-IF 211.

The memory 213 stores programs and data. The memory 213 may include a cache memory region in which data is temporarily stored, for example. The processor 212 executes a program stored in the memory 213.

The maintenance terminal 270 is a computer including an IF 275, an I/O unit 274, a memory 272, and a CPU 271 connected thereto. The IF 275 is an interface device including a port connected to the network 220. The I/O unit 274 is a user interface device such as a keyboard, a pointing device, or a display device.

The memory 272 stores a program (e.g., a maintenance program 273) and data. The CPU 271 performs maintenance of the storage system 200 by executing the maintenance program 273. For example, the CPU 271, which executes the maintenance program 273, may receive information (e.g., information indicating a distance between the storage systems 200A and 200B or information indicating a required multiplicity described later) from a user using the I/O unit 274 to set the received information in the storage system 200 via the IF 275.

FIG. 3 illustrates an example of an outline of a remote copy from the primary storage system 200A to the secondary storage system 200B.

The remote copy according to the present embodiment is an asynchronous remote copy that is performed asynchronously with processing according to a write request designating a primary volume (PVOL) 26A. The asynchronous remote copy allows the write request to be completed even when write target data accompanying the write request is not copied to a secondary volume (SVOL) 26B. The asynchronous remote copy uses a journal (JNL) described later.

The primary storage system 200A includes the PVOL 26A and the volume 26 such as a journal volume (JVOL) 26JA in which data stored in the PVOL 26A is stored as JNL data. The secondary storage system 200B includes a JVOL 26JB that is a transfer destination of a JNL stored in the JVOL 26JA, and the volume 26 such as the secondary volume (SVOL) 26B that stores JNL data in the JNL stored in the JVOL 26JB.

The PVOL 26A and the SVOL 26B constitute a VOL pair. A remote copy of the data stored in the PVOL 26A to the SVOL 26B is implemented via the JVOLs 26JA and 26JB. Any volume 26 may be based on the drive group, but at least a part of the JVOL 26J may be based on the memory 213 (e.g., the cache memory region) in the controller 210. In at least one of the storage systems 200A and 200B, one JVOL 26J may exist for a plurality of VOL pairs. A plurality of JVOLs 26J may exist for one VOL pair. The JVOLs 26J may be different in number for one VOL pair between the storage systems 200A and 200B.

The JNL includes JNL data 2524 and a journal control block (JNCB) 2523.

The JNL data 2524 is same as the write target data written in the PVOL 26A (duplication of the write target data).

The JNCB 2523 is an example of metadata of the JNL data 2524. Specifically, examples of information included in the JNCB 2523 include an address (e.g., a logical block address (LBA)) of a storage destination of the JNL data 2524, an address (address in the PVOL 26A) of a storage destination of original write target data of the JNL data 2524, an ID (an ID of the PVOL and/or an ID of an SVOL constituting the VOL pair) of the PVOL in which the original write target data is stored, and a sequence number (order of write requests accompanied by the original write target data). The sequence number (SEQ #) is an example of write order. Another example of the write order may be a time stamp.

The JVOL 26J includes a JNCB region 2521 where the JNCB 2523 is stored and a JNL data region 2522 where the JNL data 2524 is stored. As illustrated in FIG. 3, a storage destination of the JNL data 2524 can be specified from the JNCB 2523 (see an arrow extending from the JNCB 2523 to the JNL data 2524). For example, the JNCB region 2521 stores the JNCB 2523 in order of the SEQ #. The JNCB region 2521 may partially include an unused region 2527.

An outline of the remote copy is as follows, for example. That is, according to a write request from the primary host 100A, the primary storage system 200A stores write target data accompanying the write request in the PVOL 26A. The primary storage system 200A stores JNL data as a copy of the write target data and a JNL including a JNCB that is metadata of the JNL data in the JVOL 26JA, and reports write completion to the primary host 100A.

The primary storage system 200A responds to a JNL read request from the secondary storage system 200B (or spontaneously without the JNL read request) to transfer a JNL to be transferred to the secondary storage system 200B asynchronously with processing performed in response to a write request.

The secondary storage system 200B receives the JNL and stores the received JNL in the JVOL 26JB. The secondary storage system 200B stores JNL data in the JNL in the SVOL 26B based on a JNCB in the JNL. Consequently, data is remotely copied from the PVOL 26A of the primary storage system 200A to the SVOL 26B of the secondary storage system 200B.

In the following description, “JNL data” is defined as a countable noun, for convenience. This is because the JNL data is a set of data included in a “JNL” (journal) as a countable noun. For example, when there are N pieces of JNLs (N is an integer of two or more), N pieces of JNL data exist. In the present embodiment, when N pieces of JNLs are to be transferred, N pieces of JNL data are compressed by the primary storage system 200A. The JNL data is defined as a countable noun, so that write target data that is original data of the JNL data can also be defined as a countable noun. Hereinafter, compressing the N pieces of JNL data may be referred to as “collective compression”.

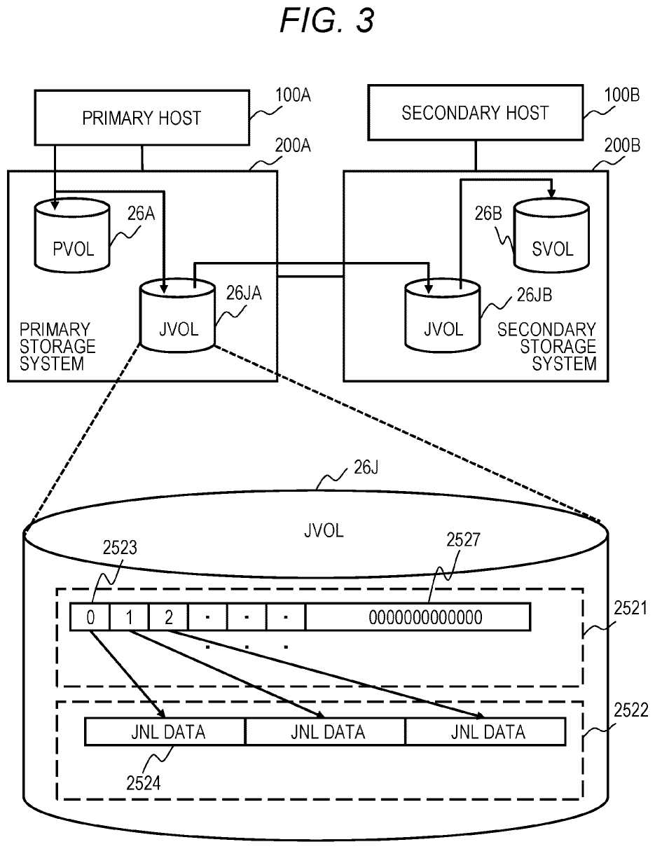

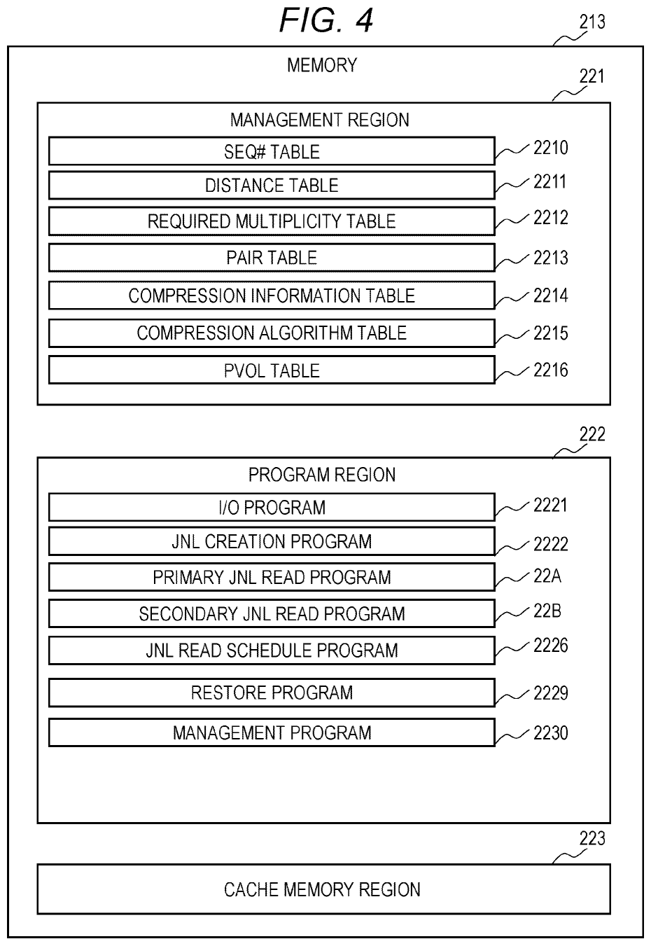

FIG. 4 illustrates a configuration example of the memory 213.

The memory 213 includes a management region 221, a program region 222, and a cache memory region 223.

The management region 221 stores management information. The management information includes an SEQ #table 2210, a distance table 2211, a required multiplicity table 2212, a pair table 2213, a compression information table 2214, a compression algorithm table 2215, and a PVOL table 2216. The information 2210 to 2212 and the information 2214 to 2216 will be described later. The pair table 2213 includes an ID of a PVOL, an ID of a SVOL, and an ID of the storage system 200 that is a copy destination, for each VOL pair. The pair table 2213 may also manage a pair state for managing a temporary stop state, normal, and abnormal of copy processing, for example.

The program region 222 stores a program. Examples of the program to be stored include an I/O program 2221 for performing I/O of data on a PVOL (or SVOL) in response to an I/O request from a host, a JNL creation program 2222 for creating JNL data, a primary JNL read program 22A for transferring a JNL, a secondary JNL read program 22B for receiving the transferred JNL, a JNL read schedule program 2226 for determining a read schedule of the JNL data, a restore program 2229 for restoring data, and a management program 2230 for acquiring a processor load of a storage.

The management program 2230 periodically stores and continuously updates processor load information on an own storage in an own storage processor load 22141 of the compression information table 2214. A valued to be stored may be an average value in a predetermined period or an instantaneous value.

The cache memory region 223 temporarily stores data.

The storage system 200 including the memory 213 can function as one or both of the primary storage system 200A and the secondary storage system 200B. For example, when the storage system 200 includes the PVOL 26A without including the SVOL 26B, the storage system 200 functions as the primary storage system 200A.

When the storage system 200 includes the SVOL 26B without including the PVOL 26A, the storage system 200 functions as the secondary storage system 200B. When the storage system 200 includes the SVOL 26B in a first VOL pair and includes the PVOL 26A in a second VOL pair, the storage system 200 functions as both the primary storage system 200A and the secondary storage system 200B.

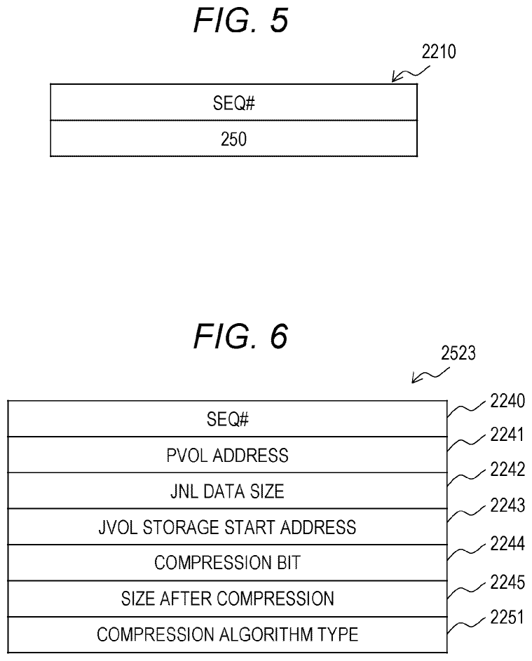

FIG. 5 illustrates a configuration example of the SEQ #table 2210.

The SEQ #table 2210 includes information for a copy source, the information indicating a SEQ # of the latest JNL (JNL created latest). Consequently, a SEQ # to be included in a JNL to be created next can be specified. Examples of the SEQ # included in the JNL to be created next include a number (e.g., a number incremented by one) next to a SEQ # indicated by the current SEQ #table 2210.

The SEQ #table 2210 may include information for the copy source, the information indicating a SEQ # of the oldest JNL (JNL including JNL data of write target data having the oldest write reception time) among JNLs not transferred to a copy destination. Consequently, a JNL to be transferred next can be specified.

Meanwhile, the SEQ #table 2210 includes information for a copy destination, the information indicating a SEQ # of a JNL that is the oldest among JNLs that are not reflected in an SVOL. Consequently, a SEQ # included in a JNL to be reflected next can be specified. The SEQ #table 2210 may include information for the copy destination, the information indicating a SEQ # of a JNL that is the oldest among JNLs that have not been received from the copy source. Consequently, a JNL to be requested next to the primary storage system 200A can be specified.

FIG. 6 illustrates a configuration example of the JNCB 2523.

The JNCB 2523 includes information such as a SEQ #2240, a PVOL address 2241, a JNL data size 2242, a JVOL storage start address 2243, a compression bit 2244, a compressed size 2245, and a compression algorithm type 2251.

The SEQ #2240 represents a SEQ # allocated to a JNL managed by the JNCB 2523. The PVOL address 2241 indicates an address (e.g., an ID of the PVOL 26A and a LBA of a region of the PVOL 26) of the PVOL 26A. The JNL data size 2242 indicates a size of the JNL data 2524 in the same JNL as that of the JNCB 2523. The JVOL storage start address 2243 is an address of a region in the JVOL 26JA, and indicates a start address of the region in which the JNL data 2524 is stored.

The compression bit 2244 indicates whether the JNL data 2524 stored in the JVOL 26JA is compressed. When compression (compression of single JNL data or the collective compression) is always executed, the compression bit 2244 may not be provided. When the primary storage system 200A and the secondary storage system 200B mutually recognize that compression is to be performed, the compression bit 2244 is not required to be provided in the JNCB 2242.

The compressed size 2245 is valid information when the compression bit 2244 is “ON” (value meaning compression), and indicates a size of JNL data after compression. The compressed size 2245 after the collective compression indicates a collective compression size that is a data size of collective compressed data (N pieces of JNL data having been collectively compressed). Each of N pieces of JNCBs corresponding to the N pieces of JNL data after the collective compression may store the compression bit 2244 being “ON” and a size after the same collective compression. Information 2251 is valid when the compression bit 2244 is “ON”, and indicates information for specifying a compression algorithm used for compressing the JNL data.

The information 2251 is valid when the compression bit 2244 is “ON” (a value meaning compression), and indicates which compression algorithm has been used to compress the JNL data. When compression algorithms used in the primary storage and the secondary storage are identical with no difference, the information 2251 may not be provided.

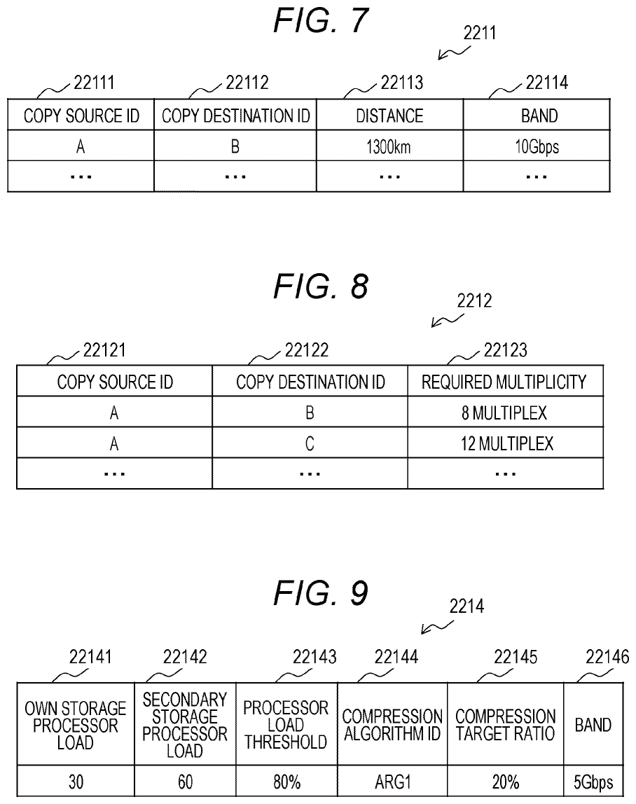

FIG. 7 illustrates a configuration example of the distance table 2211.

The distance table 2211 holds information such as a copy source ID22111, a copy destination ID22112, a distance 22113, and a band 22114 for each pair of the primary and secondary storage systems 200 A and 200B.

The copy source ID 22111 indicates an ID of the primary storage system 200A. The copy destination ID 22112 indicates an ID of the secondary storage system 200B. The distance 22113 indicates a geographical distance between the primary and secondary storage systems 200A and 200B. The band 22114 indicates a data transfer band between the primary and secondary storage systems 200A and 200B. This value is information for calculating a required multiplicity of data transfer processing between the primary storage system 200A and the secondary storage system 200B. Thus, a round-trip communication time between the primary storage system 200A and the secondary storage system 200B can also be substituted.

FIG. 8 illustrates a configuration example of the required multiplicity table 2212.

The required multiplicity table 2212 holds information such as a copy source ID 22121, a copy destination ID 22122, and a required multiplicity 22123 for each pair of the primary and secondary storage systems 200A and 200B.

The copy source ID 22121 indicates an ID of the primary storage system 200A. The copy destination ID 22122 indicates an ID of the secondary storage system 200B. The required multiplicity 22123 indicates a multiplicity of data transfer processing required between the primary and secondary storage systems 200A and 200B.

FIG. 9 illustrates a configuration example of the compressed information table 2214.

The own storage processor load 22141 indicates information on a processor load of a storage in which the compression information table 2214 is located. The management program 2230 stores this information. A secondary storage processor load 22142 indicates a processor load of the secondary storage. The primary JNL read program 22A stores this information. The processor load may be calculated from a load of one or more processors performing a remote copy, or a load of all processors of a storage system, for example. The processor load may be an average value of the most recent predetermined period of one or more target processors, or a weighting factor for time or a processor may be used as the processor load, for example.

A processor load threshold 22143 indicates a reference value used for determining whether the own storage processor load 22141 or the secondary storage processor load 22142 is high. A default value may be stored in advance for the reference value, or the reference value may be input from an administrator through the maintenance terminal 270, or may be dynamically updated with reference to other information, for example. For each of the own storage and the secondary storage, an equal or a different processor load threshold may be designated.

A compression algorithm ID 22144 indicates an identifier of a compression algorithm used when JNL data is compressed. Any compression algorithm ID in the compression algorithm table 2215 is stored. An ARG 1 with a medium load is stored as a default value.

Although a compression target ratio 22145 is not used in the first embodiment, it indicates the number of JNL data to be compressed or a ratio of PVOL as a processor load reduction measure. A default value may be stored in advance as the compression target ratio 22145, or the compression target ratio 22145 may be input from the administrator via the maintenance terminal 270.

A band 22146 stores a maximum band (transfer rate) of a line used for transfer in the remote copy. The management program 2230 acquires information on a port used for the remote copy and periodically stores and updates the information.

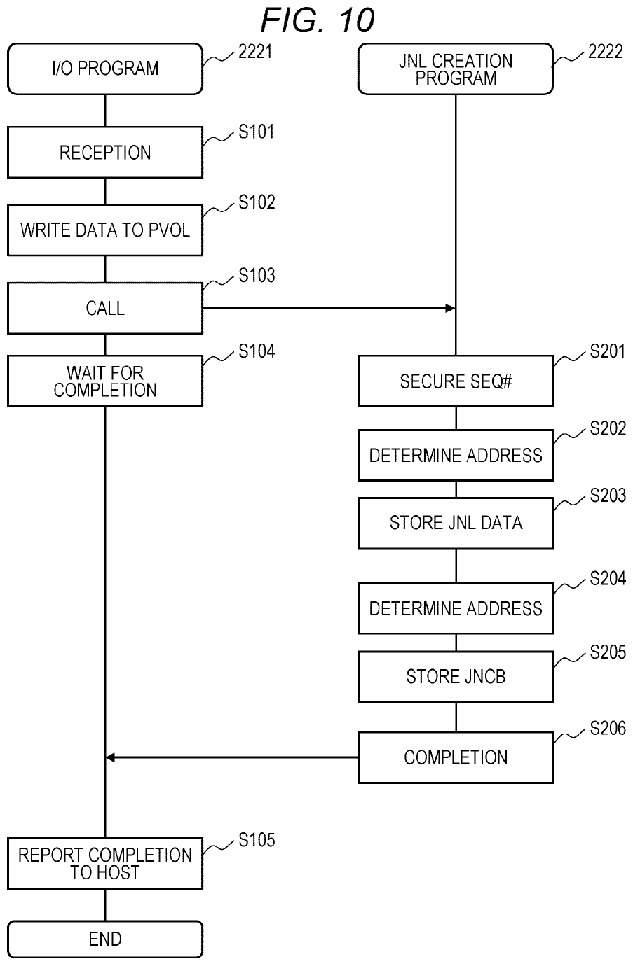

FIG. 10 illustrates a processing flow of write processing performed by the primary storage system 200A.

The I/O program 2221 receives a write request from the primary host 100A (S101). The I/O program 2221 writes write target data accompanying the received write request to the PVOL 26A (S102), calls the JNL creation program 2222 (S103), and waits for completion of the JNL creation program 2222 (S104). The write target data may be temporarily stored in the cache memory region 223 and then written to the PVOL 26A, or may be written to the PVOL 26A without being stored in the cache memory region 223.

The JNL creation program 2222 having been called ensures the latest SEQ # (SEQ # after incrementing the current latest SEQ #) (S201). The JNL creation program 2222 determines a storage destination address (e.g., a JVOL storage start address) of the JNL data (S202), creates JNL data as a copy of the data written in S102 (e.g., the data on the cache memory region 223), and stores the JNL data in a region (e.g., the cache memory region 223 or the JNL data region 2522) indicated by the address determined in S202 (S203).

The JNL creation program 2222 also determines a storage destination address of a JNCB (S204), creates the JNCB including the SEQ # secured in S201, and stores the JNCB in a region (e.g., the cache memory region 223 or the JNCB region 2521) indicated by the address determined in S204 (S205). The JNL creation program 2222 then notifies the I/O program 2221 of completion of the processing (S206).

When receiving the completion notification from the JNL creation program 2222, the I/O program 2221 reports the write completion to the primary host 100A (an example of a transmission source of the write request) (S105). The write completion is reported without waiting for storage of journal data or completion of collective compression. In other words, the collective compression is performed asynchronously with the write processing.

When the JNCB and the JNL data are stored in the cache memory region 223 of the primary storage system 200A in the write processing, the JNCB and the JNL data may be stored the JVOL 26A later from the cache memory region 223. When the JVOL 26A is a region based on the cache memory region 223, storage in the cache memory region 223 may correspond to storage in the JVOL 26A.

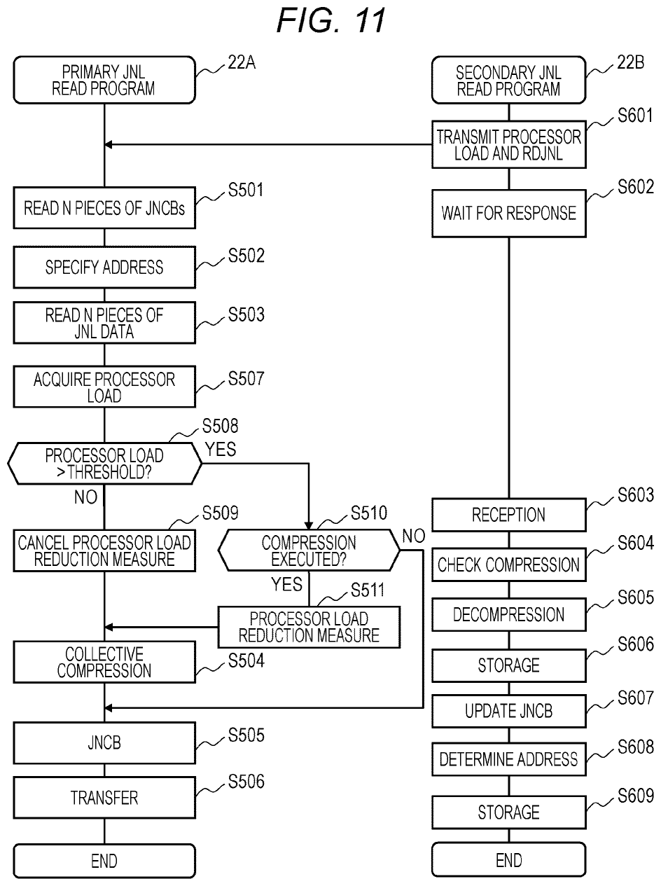

In the present embodiment, the JNL data is transferred from the primary storage system 200A to the secondary storage system 200B according to a processing flow illustrated in FIG. 11.

FIG. 11 illustrates a processing flow of JNL transfer processing.

The present processing flow is for N pieces of JNL data having been collectively compressed, which are to be transferred.

The secondary JNL read program 22B of the secondary storage system 200B transmits a journal read request (RDJNL), which is a read request of a JNL in which the processor load 22141 of the secondary storage system is acquired from the compression information table 2214 and is stored, to the primary storage system 200A (S601), and waits for a response from the primary storage system 200A (S602).

In response to the RDJNL received from the secondary storage system 200B, the primary JNL read program 22A of the primary storage system 200A reads N pieces of JNCBs 2523, which have not been transferred, from the JVOL 26JA (S501), and specifies the JVOL storage start address 2243 of each of the N pieces of JNCBs 2523 (S502). The primary JNL read program 22A reads JNL data from each address specified in S502 (S503).

The primary JNL read program 22A stores a processor load acquired from the RDJNL in the secondary storage processor load 22142 of the compression information table 2214 (S507).

The primary JNL read program 22A refers to the own storage processor load 22141, the secondary storage processor load 22142, and the processor load threshold 22143 of the compression information table 2214 and compares whether the own storage processor load 22141 or the secondary storage processor load 22142 is larger than the processor load threshold 22143.

When any one of the processor loads is larger than the processor load threshold, the primary JNL read program 22A executes S510. When both the processor loads are equal to or less than the processor load threshold (NO in S508), the primary JNL read program 22A executes S504. In the first embodiment, S509 is skipped without being processed. The determination in S508 may not be performed for a predetermined period to prevent a determination result from changing frequently, so that processing identical to that in the previous determination result may be continued.

In the first embodiment, the primary JNL read program 22A constantly determines that no compression is executed (NO in S510), and executes S505. The primary JNL read program 22A performs collective compression of the N pieces of JNL data having been read (S504).

The primary JNL read program 22A updates the N pieces of JNCBs 2523 corresponding to the N pieces of JNL data (S505). Each JNCB 2523 updated in S505 shows the compressed bit 2244 that is “ON” and the compressed size 2245 that indicates a size after the collective compression.

When determining that no compression is performed in S510, the primary JNL read program 22A sets the compression bit 2244 to “OFF” when updating the JNCB 2523. The primary JNL read program 22A transfers the collective compressed data (N pieces of JNL data having been collectively compressed) and the N pieces of JNCBs 2523 having been updated to the secondary storage system 200B (S506).

Instead of updating the compressed bit 2244 and the compressed size 2245 of each JNCB 2523, only information on the JNCB 2523 having the smallest SEQ # among the JNLs to be transferred may be updated, for example. The primary JNL read program and the secondary JNL read program process each JNL by using information on the JNCB 2523 having the smallest SEQ #.

The secondary JNL read program 200B of the secondary storage system 22B receives the N pieces of JNCBs 2523 and the collective compressed data from the primary storage system 200A (S603). The secondary JNL read program 22B specifies the compression bit 2244 being “ON” from each of the N pieces of JNCBs 2523 (S604), and decompresses the collective compressed data into N pieces of JNL data (S605). The decompression may be performed by the secondary JNL read program 22B, or may be performed by an accelerator of the secondary storage system 200B. When the decompression is performed by using the accelerator, a processor load is calculated including processor load information on the accelerator.

The secondary JNL read program 22B determines a storage destination address (e.g., a JVOL storage start address) for each JNL data, and stores the JNL data in a region (e.g., the cache memory region 223 or the JNL data region 2522) indicated by the determined address (S606). Using the decompressed data and the JNL data size 2242 stored in the N pieces of JNCBs 2523 enables specifying JNL data corresponding to each JNCB 2523. Specifically, the decompressed data is divided by the JNL data size 2242 in ascending order of SEQ #.

The secondary JNL read program 22B updates each of the N pieces of JNCBs 2523 (S607). Each JNCB 2523 updated in S607 shows the JVOL storage start address 2243 that is an address of a region in the JVOL 26JB, the compression bit 2244 that is “OFF”, and the compressed size 2245 that is an invalid value. The secondary JNL read program 22B determines a storage destination address of each JNCB updated in S607 (S608), and stores each JNCB in a region (e.g., the cache memory region 223 or the JNCB region 2521) indicated by the address determined in S607 (S609).

The decompression of the compressed data may be executed in the restore program described in FIG. 13. In this case, S604 and S605 are skipped, and S606 is executed to store the compressed data. In S607, the JVOL storage start address 2243 is changed to an address of a region in the JVOL 26JB. The compression bit 2244 and the compressed size 2245 are not changed.

According to the above processing, all the write target data are to be transferred, so that a short recovery point objective (RPO) is maintained. The N pieces of JNL data after being collectively compressed are to be transferred, so that an improvement in reduction effect of data to be transferred is expected. Additionally, when the processor of the primary or secondary storage is under a high load, data is transferred without compression. Thus, an effect of maintaining a short RPO can be expected by preventing deterioration in copy performance due to overhead of compression processing or decompression processing.

At least one of the following may be used.

Instead of S604 to S609, the collective compressed data and the N pieces of JNCBs may be stored in the JVOL 26JB. At the time of reflecting the JNL in the SVOL 26B (i.e., at the time of restore processing), the collective compressed data may be decompressed into N pieces of JNL data, and the N pieces of JNL data having been decompressed may be written in the SVOL 26B.

Processing of reflecting the JNL in the SVOL 26B needs to process the JNL transferred by one JNL read program. For example, a case is considered in which the JNL read program transfers the JNLs of SEQ #s 1 to 50 in the first processing and transfers the JNLs of SEQ #s 51 to 100 in the second processing. The restore processing also needs to be performed on the SEQ #s 1 to 50. This is because the JNL data of the SEQ #s 1 to 50 is collectively compressed. When the compression start SEQ #2248 and the compression end SEQ #2250 are stored in the JNCB 2523, the SEQ #s 1 to 50 being collectively compressed can be recognized for the restore processing.

A form copy according to the asynchronous remote copy (a copy for initially matching the PVOL 26A and the SVOL 26B) may also include processing similar to processing illustrated in FIG. 11. At that time, the JNL data is read from the PVOL 26A instead of the JVOL 26JA in S503.

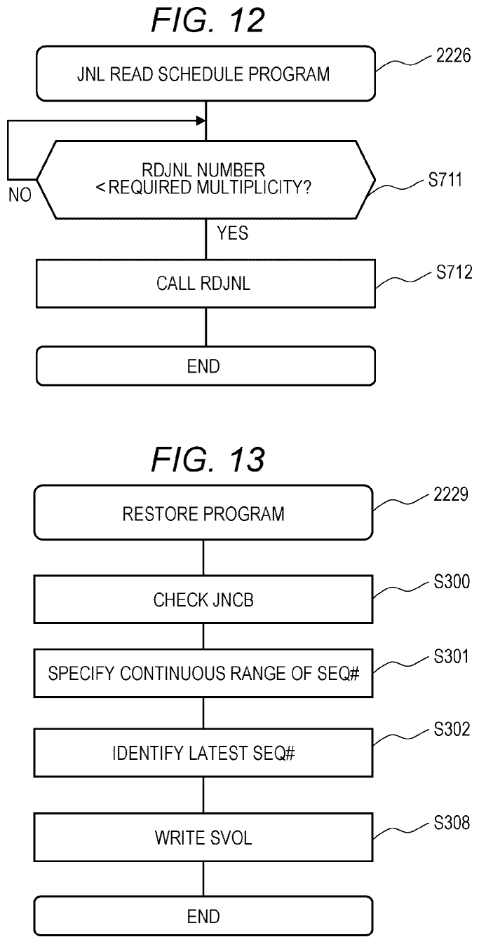

FIG. 12 illustrates a processing flow of the JNL read schedule program 2226.

In the secondary storage system 200B (or the primary storage system 200A), the JNL read schedule program 2226 refers to the required multiplicity table 2212 and determines whether the number of RDJNLs (the number of RDJNLs in processing) is less than the required multiplicity (S711).

When a determination result in S711 is true (Yes in S711), the JNL read schedule program 2226 calls the secondary JNL read program 22B (S712). Consequently, the RDJNL is transmitted from the secondary JNL read program 22B to result in increase in number of RDJNLs. The determination in S711 is reflected by accessing the required multiplicity table 2212 to acquire the required multiplicity.

FIG. 13 illustrates a processing flow of the restore program 2229.

In the secondary storage system 200B, the restore program 2229 checks JNCBs stored in the JVOL 26JB (S300), specifies a range in which SEQ #s are continuous from the oldest SEQ # among JNLs not reflected in the SVOL 26B (S301), and specifies the latest SEQ # in the specified range (S302).

When the compressed data is decompressed in the restore program, the restore program 2229 determines whether the compressed bit 2244 is “ON” and a divided bit 2246 is “ON” for each of the SEQ #s in the range, in which the SEQ #s are continuous, in a JNCB including the SEQ #.

When the determination result is false, the restore program 2229 performs SVOL write (S308). In S308, the following is performed.

When the compression bit 2244 is “ON”, the restore program 2229 specifies N pieces of JNCBs (e.g., N pieces of JNCBs identical in compression start SEQ # and compression end SEQ #) corresponding to the collective compression, and reads collective compressed data from the JVOL 26B based on the N pieces of JNCBs to decompress the collective compression data, thereby acquiring N pieces of JNL data. For each of the N pieces of JNCBs, the restore program 2229 writes JNL data corresponding to the JNCB in a region in a SVOL indicated by an address corresponding to a PVOL address indicated by the JNCB.

When the compressed bit 2244 is “OFF” or when the compressed data is not decompressed in the restore program 2229 and is decompressed in the secondary JNL read program, the restore program 2229 specifies a JNCB in a JNL that is the oldest in JNLs being not reflected in the SVOL 26B, and reads JNL data from the JVOL 26JB based on the JNCB. The restore program 2229 writes the JNL data having been read in a region in a SVOL indicated by an address corresponding to a PVOL address indicated by the JNCB.

The first embodiment has been described above. In the present embodiment, “remote copy processing” is until JNL data, which is a copy of data written in the PVOL 26A, is reflected in the SVOL 26B via the JVOLs 26JA and 26JB. The remote copy processing includes the JNL transfer processing and the restore processing.

The “JNL transfer processing” is from a start of processing for transferring a JNL until storage of the transferred JNL ends. In the present embodiment, the processing is from when transmission of an RDJNL is started by the secondary storage system 200B until a JNL included in a response to the RDJNL (a response from the primary storage system 200A) is stored in the secondary storage system 200B. The “restore processing” is performed to write JNL data to the SVOL 26B in the secondary storage system 200B, and is specifically illustrated in FIG. 13, for example.

Although data is transferred in response to an RDJNL from the secondary storage system 200B in the present embodiment, a write request of a JNL (WRJNL) may be transmitted from the primary storage system 200A to the secondary storage system 200B, and data accompanying the WRJNL (at least a part of a plurality of JNCBs and collective compressed data) may be stored in response to the WRJNL.

In that case, processor load information on the secondary storage may be included in the response to the WRJNL from the secondary storage, the processor load information on the secondary storage may be obtained via a maintenance terminal before the WRJNL is transmitted from the primary storage, or the processor load information may be individually acquired by transmitting a processor acquisition request to the secondary storage. Additionally, compression may be designated in an RDJNL, and collective compression may be performed due to the compression designated in the RDJNL.

When compression is not designated in an RDJNL, uncompressed JNL data may be to be transferred. Although the information illustrated in FIG. 6 is stored in a JNCB, the information may be stored and transferred as a parameter of a command of a WRJNL or an RDJNL. Although a JNCB is an example of metadata on a journal, the metadata may be associated as a parameter of a command of a WRJNL or an RDJNL.

As described above, one method for transferring data is selected from a plurality of methods for transferring data based on a processor load of the primary storage system and a processor load of the secondary storage system in the present embodiment. The plurality of methods for transferring data is different in compression processing on transfer data. One configuration example includes the plurality of methods for transferring data including two methods for transferring data in which a first method for transferring data compresses all transfer data, and a second method for transferring data has no compression processing on the transfer data. That is, the second method for transferring data has a smaller processor load for compression than the first method for transferring data. When one method for transferring data is selected from methods for transferring data, different in a processor load for compression processing, in accordance with processor loads of the primary storage system and the secondary storage system, copy performance can be prevented from deteriorating.

### Second Embodiment

A second embodiment will be described. At that time, differences from the first embodiment will be mainly described, and description of points common to the first embodiment will not be described or simplified (the same applies to embodiments described later other than the second embodiment). In the present embodiment, multiple compression algorithms different in a processor load are prepared as options, and when the primary storage or the secondary storage has a high processor load, a compression algorithm having a smaller processor load is selected.

FIG. 14 illustrates a configuration example of the compression algorithm table 2215. A compression algorithm ID 22151 indicates an ID for identifying a compression algorithm. A load 22152 indicates a load added to a processor during processing of a compression algorithms. A compression algorithm with a high load achieves a higher compression ratio.

In the second embodiment, it is always determined in S510 that compression is executed (YES in S510).

The primary JNL read program 22A refers to information on a compression algorithm with a low load from the compression algorithm table 2215, and stores an ARG2 in the compression algorithm ID 22144, for example (S511). The primary JNL read program 22A holds all algorithms in the compression algorithm table 2215, and compresses JNL data using a compression algorithm indicated by an ID stored in the compression algorithm ID 22151 for processing in S504.

According to the processing above, all write target data are to be transferred, so that a short RPO is maintained. The N pieces of JNL data after being collectively compressed are to be transferred, so that an improvement in reduction effect of data to be transferred is expected. Additionally, when the processor of the primary or secondary storage is under a high load, data is compressed and transferred by using a compression algorithm with a low load. Thus, an effect of maintaining a short RPO can be expected by reducing deterioration in copy performance due to overhead of compression processing or decompression processing.

The compression algorithm table 2215 illustrated in FIG. 14 indicates three types of compression algorithm. Each compression algorithm may be associated with a different range of processor loads. For example, ranges of processor loads of an intermediate load, a low load, and a high load can be defined by two thresholds. Algorithms with a medium load, a high load, and a low load may be associated with ranges of processor loads of a medium load, a low load, and a high load, respectively. The number of types of compression algorithm used is any number of two or more.

### Third Embodiment

A third embodiment will be described. In the present embodiment, a plurality of methods for transferring data is prepared as options, one transfer method thereof performs compression processing on all of transfer data, and the other transfer method selectively compresses compression target data that is a part of the transfer data. Reducing the compression target data enables a processor load for compression to be reduced.

In the third embodiment, it is always determined in S510 that compression is executed (YES in S510). The primary JNL read program 22A processes the number of RDJNLs to be compressed such that the number approaches the compression target ratio 22145, as the processor load reduction measure in S511.

The primary JNL read program 22A acquires the compression target ratio 22145 (S511). At a compression target ratio 22145 of 20%, the primary JNL read program 22A executes processing in which one piece of RDJNL is compressed and then next four pieces thereof are not compressed (S504), for example.

In another example, the primary JNL read program 22A may execute processing in which the number of JNL data 2524 to be compressed approaches the compression target ratio 22145. For example, the JNL data 2524 to be compressed is selected in order from the head to cause the number of compressions of the JNL data 2524 to be closest to 20 for each RDJNL. When the RDJNL or JNL data is constant in size, control is performed such that a ratio of the amount of compression target data approaches a predetermined value. When the size is not constant, control is performed such that the amount of compression target data approaches a predetermined value by adjusting the number of compression target data.

The compression target ratio 22145 may be changed in accordance with a processor load. For example, different compression target ratios are allocated to respective three or more ranges different in a processor load. As the processor load increases, the compression target ratio decreases. An algorithm is selected suitable for the primary storage or the secondary storage, having a higher processor load. Based on a criterion different from the number of compression target data, some compression target data may be selected such that a ratio of the amount of compressed data approaches a predetermined value, for example.

According to the processing above, all write target data are to be transferred, so that a short RPO is maintained. The N pieces of JNL data after being collectively compressed are to be transferred, so that an improvement in reduction effect of data to be transferred is expected. Additionally, when the processor of the primary or secondary storage is under a high load, data is compressed and transferred in accordance with the compression target ratio 22145. Thus, an effect of maintaining a short RPO can be expected by reducing deterioration in copy performance due to overhead of compression processing or decompression processing.

### Fourth Embodiment

A fourth embodiment will be described. In the present embodiment, a plurality of methods for transferring data is prepared as options, one transfer method thereof performs compression processing on transfer data of all copy source volumes, and the other transfer method selectively compresses transfer data on a part of the copy source volumes. Reducing a volume to be compressed enables a processor load for compression to be reduced.

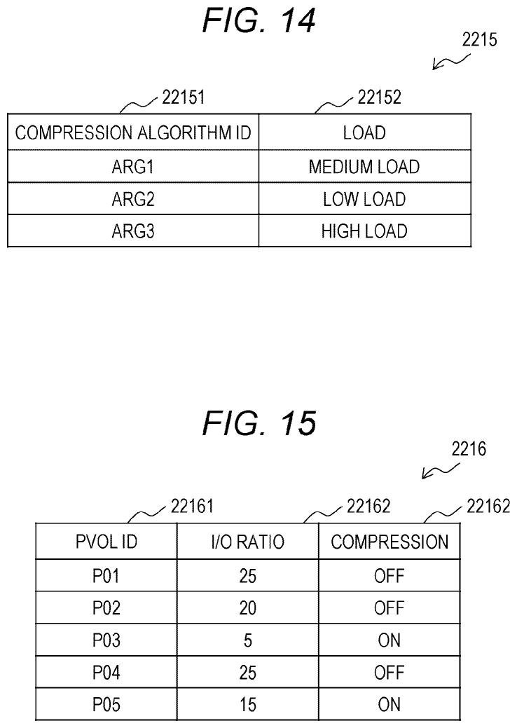

In the fourth embodiment, it is always determined in S510 that compression is executed (YES in S510). FIG. 15 illustrates a configuration example of the PVOL table 2216. The PVOL ID 22161 indicates an ID for identifying a PVOL. An I/O ratio indicates a ratio of I/O processed by the PVOL among I/O from the host to all PVOLs. Compression 22163 indicates whether to perform compression in S504. The compression is performed when ON is indicated, and no compression is performed when OFF is indicated.

The primary JNL read program 22A acquires the compression target ratio 22145 (S511). At a compression target ratio 22145 of 20%, the primary JNL read program 22A selects a PVOL to cause the total of ratios of the I/O of the PVOL to be compressed to be closest to 20% and performs processing of compression of the JNL data (S504).

The compression target ratio 22145 may be changed in accordance with a processor load. For example, different compression target ratios are allocated to respective three or more ranges different in a processor load. As the processor load increases, the compression target ratio decreases. A compression target ratio is selected suitable for the primary storage or the secondary storage, having a higher processor load. Based on a criterion different from the host I/O, a part of the volume to be compressed may be selected such that the amount of user data stored in the volume approaches a predetermined ratio, for example.

According to the processing above, all write target data are to be transferred, so that a short RPO is maintained. The N pieces of JNL data after being collectively compressed are to be transferred, so that an improvement in reduction effect of data to be transferred is expected. Additionally, when the processor of the primary or secondary storage is under a high load, only some of PVOLs is compressed and transferred. Thus, an effect of maintaining a short RPO can be expected by reducing deterioration in copy performance due to overhead of compression processing or decompression processing.

### Fifth Embodiment

A fifth embodiment will be described. The fifth embodiment also includes a condition whether there is a free space in a line band used in a remote copy as a determination condition in S508. Data transfer method selection conditions of the present embodiment include an item of a line band in addition to an item of the processor load of any one of the first to fourth embodiments.

The primary JNL read program 22A refers to the band 22146 and the band 22114, and determines whether there is a free space of 2/3 or more in the line band, for example. When there is the free space and a processor load is larger than a threshold, YES is determined in S508. It is determined in S510 that compression is not executed, and then processing in S505 is performed.

A threshold (reference criterion) for a free region of the line band is not particularly limited. When three or more compression modes, such as a compression algorithm and a compression target ratio, are set for a processor load, a minimum necessary free region in the line band may be set for each compression mode. A common minimum value may be set for a plurality of compression modes, or different minimum values may be set.

According to the processing above, all write target data are to be transferred, so that a short RPO is maintained. The N pieces of JNL data after being collectively compressed are to be transferred, so that an improvement in reduction effect of data to be transferred is expected. Additionally, data is transferred without compression only when the processor of the primary or secondary storage is under a high load and the line band has a sufficient free space. Thus, an effect of maintaining a short RPO can be expected by reducing deterioration in copy performance due to overhead of compression processing or decompression processing, or a bottleneck in the line band.

The present invention is not limited to the embodiments described above, and includes various modifications. For example, the embodiments described above have been described in detail to describe the present invention in an easy-to-understand manner, and are not necessarily limited to those having all the configurations described. A part of a configuration of one embodiment can be replaced with a configuration of another embodiment, and the configuration of the other embodiment can be added to the configuration of the one embodiment. Additionally, addition, deletion, and replacement of another configuration is allowed for a part of a configuration of each embodiment.

Some or all of the configurations, functions, processing units, and the like described above may be implemented by hardware designed with an integrated circuit, for example. The configurations, functions, and the like described above may be implemented by software using a processor interpreting and executing a program for implementing each function. Information such as a program, a table, and a file for implementing each function can be stored in a recording device such as a memory, a hard disk, or an SSD, or a recording medium such as an IC card or an SD card.

Control lines and information lines considered to be necessary for the description are indicated, and thus all control lines and information lines are not necessarily indicated. In practice, almost all the configurations may be considered to be connected to each other.

1. A storage system that transmits copy data to a copy destination storage system, the storage system comprising:
a controller; and
a storage drive that stores user data,
wherein the controller being configured to
acquire processor load information on the controller and processor load information on the copy destination storage system, and
select one transfer method from a plurality of transfer methods for transferring the user data to the copy destination storage system based on a processor load of the controller and a processor load of the copy destination storage system,
the plurality of transfer methods including:
a first transfer method for performing compression processing on transfer data; and
a second transfer method for performing no compression processing on the transfer data or performing compression processing on the transfer data with a lower processor load than the first transfer method,
the first transfer method being selected under conditions including a condition where each of processor loads of the controller and the copy destination storage system is equal to or less than a threshold, and
the second transfer method being selected under conditions including a condition where at least one of the processor loads of the controller and the copy destination storage system is more than the threshold.

2. The storage system according to claim 1, wherein the second transfer method is selected under the conditions including a condition where a free region of a line band for the copy destination storage system is larger than a threshold.

3. The storage system according to claim 1, wherein
the second transfer method performs compression processing on the transfer data, and
the second transfer method uses a compression algorithm with a processor load smaller than a processor load of a compression algorithm in the first transfer method.

4. The storage system according to claim 1, wherein
the first transfer method performs compression processing on all the transfer data, and
the second transfer method selectively compresses compression target data that is a part of the transfer data.

5. The storage system according to claim 4, wherein the second transfer method selects the compression target data to have a ratio of the compression target data in the transfer data, the ratio being close to a predetermined value.

6. The storage system according to claim 1, wherein
the first transfer method performs compression processing on all the transfer data, and
the second transfer method selectively compresses data on a target volume that is a part of a copy source volume of the transfer data.

7. The storage system according to claim 6, wherein the second transfer method selects the target volume to have a ratio of a total of host I/Os of the target volume in the host I/O for the copy source volume, the ratio being close to a predetermined value.

8. A method for transferring data from a copy source storage system to a copy destination storage system, the method comprising:
causing the copy source storage system to acquire processor load information on the copy source storage system and processor load information on the copy destination storage system; and
causing the copy source storage system to select one transfer method from a plurality of transfer methods from the copy source storage system to the copy destination storage system based on a processor load of the copy source storage system and a processor load of the copy destination storage system,
wherein the plurality of transfer methods including:
a first transfer method for performing compression processing on transfer data; and
a second transfer method for performing no compression processing on the transfer data or performing compression processing on the transfer data with a processor load lower than a processor load of the first transfer method,
the first transfer method being selected under conditions including a condition where each of a processor load of the copy source storage system and a processor load of the copy destination storage system is equal to or less than a threshold, and
the second transfer method being selected under conditions including a condition where at least one of the processor load of the copy source storage system and the processor load of the copy destination storage system is higher than the threshold.
